(19) United States
(12) Patent Application Publication
(10) Pub. No.: US 2013/0162685 A1
(43) Pub. Date: Jun. 27, 2013

(54) INTERACTIVE DISPLAY OF VERY LARGE FILES USING B PLUS TREES AND STABILIZED SUBSAMPLING

(71) Applicant: Larry E. Wickstrom, Portland, OR (US)

(72) Inventor: Larry E. Wickstrom, Portland, OR (US)

(21) Appl. No.: 13/337,787

(22) Filed: Dec. 27, 2011

(51) Int. Cl. G06T 11/00

(52) U.S. Cl. 345/660; 345/440

(57) ABSTRACT

Systems and methods may provide for populating a B plus tree with a relatively large set of data wherein, in response to a display request associated with the set of data, one or more visibility parameters may be identified. In addition, a hierarchical sampling scheme may be used to identify one or more sample points in the B plus tree based on the visibility parameters. Moreover, the sample points can be used to obtain sample data from the B plus tree, wherein a display response is generated based on the sample data.

### BACKGROUND

Displaying large amounts of data can be advantageous in certain situations. For example, a graphics platform analyzer tool may enable users to view and interact with millions of task files associated with games, media, and other graphics intensive applications. The display of such large data sets may be challenging, however, particularly if the data is non-uniform. For example, if the tool permits the user to pan across a non-uniform set of data or zoom into the data, conventional approaches to storing the data may create undesirable visual artifacts such as the unexpected disappearance of data as a result of the zoom and/or pan operation.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a timeline representation of a non-uniform data set according to an embodiment;

FIG. 2 is a block diagram of an example of a B plus tree that stores a non-uniform set of data according to an embodiment;

FIG. 3A is a flowchart of an example of a method of creating a B plus tree according to an embodiment;

FIG. 3B is a flowchart of an example of a method of processing display requests according to an embodiment;

FIG. 4 is a block diagram of an example of a hierarchical sampling scheme according to an embodiment;

FIG. 5 is a block diagram of an example of an application of a hierarchical sampling scheme to a non-uniform set of data stored in a B plus tree according to an embodiment;

FIG. 6 is a block diagram of an example of a system according to an embodiment;

FIG. 7 is a block diagram of an example of a system having a navigation controller according to an embodiment; and

FIG. 8 is a block diagram of an example of a system having a small form factor according to an embodiment.

### DETAILED DESCRIPTION

Embodiments may include a computer implemented method in which a display request associated with a set of data is received. The method can provide for using the display request to obtain sample data from a B plus tree populated with the set of data, and generating a display response based on the sample data.

Embodiments may also include a computer readable storage medium having a set of instructions which, if executed by a processor, cause a computer to receive a display request associated with a set of data. The instructions can also cause a computer to use the display request to obtain sample data from a B plus tree populated with the set of data, and generate a display response based on the sample data.

Additionally, embodiments may include a system having one or more memory devices to store a set of data in a B plus tree, and logic to receive a display request associated with the set of data. The logic can also use the display request to obtain sample data from the B plus tree, and generate a display response based on the sample data. The system may also have a display device to output the display response.

Other embodiments can include a computer implemented method in which a set of data is received, wherein the method provides for parsing the data and populating a B plus tree with the parsed set of data. A display request associated with the set of data may also be received. Additionally, one or more visibility parameters may be identified based on the display request, wherein the one or more visibility parameters include one or more of a visibility region and a number of visible pixels. The method can also provide for using a hierarchical sampling scheme to identify one or more sample points in the B plus tree based on the one or more visibility parameters. In addition, the one or more sample points can be used to obtain sample data from the B plus tree, wherein the method provides for generating a display response based on the sample data.

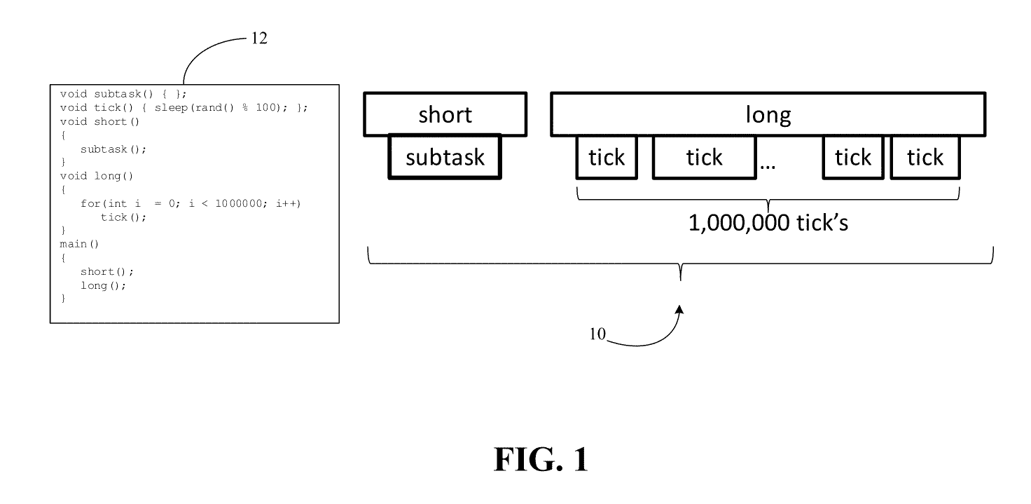

Turning now to FIG. 1, a timeline representation 10 of a non-uniform set of data resulting from the execution of instrumented code 12 is shown. In the illustrated example, instrumentation of the code 12 results in the generation of trace information during execution of the code 12, wherein the trace information can provide the ability to monitor and/or measure the performance of the code 12, as well as to diagnose errors in the code 12. Thus, the trace information may constitute a set of data that could be quite large depending upon the complexity of the code 12. Indeed, it is not uncommon for a typical graphics application to result in trace information that includes eleven million trace-related task files or more. Moreover, the trace information may be non-uniform in the sense that certain portions of the code 12 can generate more trace information than others.

For example, the illustrated code 12 includes various functions such as “short( )”, “subtask( )”, “long( )” and “tick( )”, wherein the short( ) function calls the subtask( ) function, which occupies a relatively small amount of time in the timeline representation 10. The long( ) function, on the other hand, calls the tick( ) function, wherein the illustrated tick( ) function is iterated one million times. As a result, the long( ) function occupies a relatively large amount of time in the timeline representation 10. As will be discussed in greater detail, sets of data such as the data set reflected in the timeline representation 10 may be stored and accessed in a B plus tree in order to enhance the viewing of the data set.

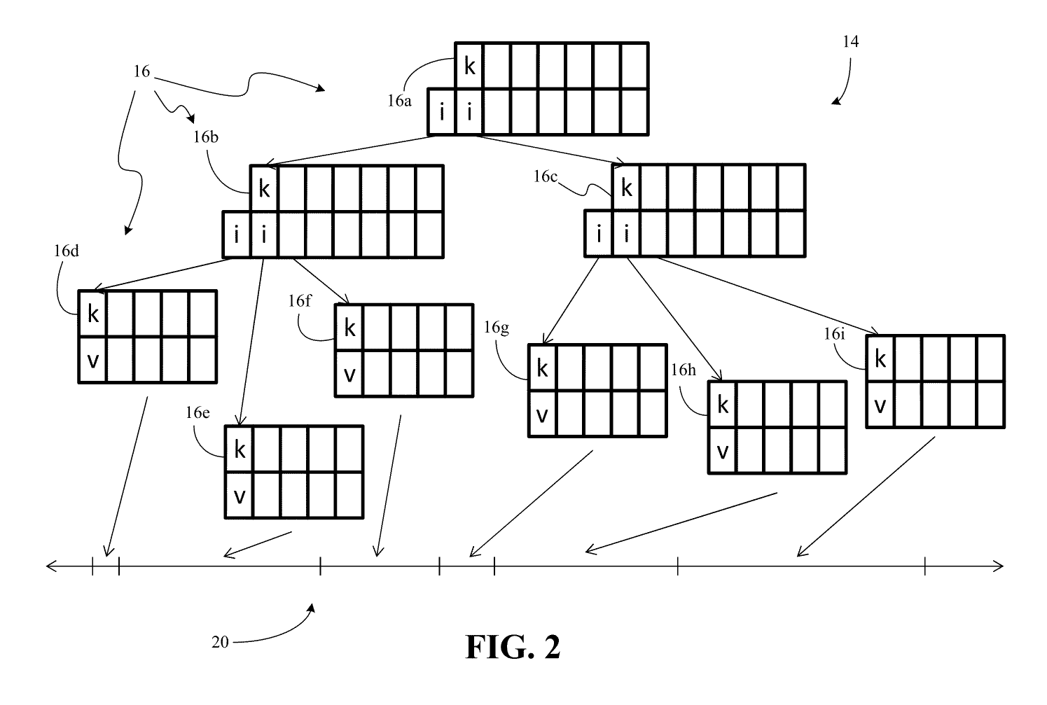

FIG. 2 shows a B plus tree 14 that may be sorted by a set of keys (“k”) 16 (16a-16i), wherein each key 16 includes either a set of indices (“i”) to other keys 16 or a set of values (“v”) in a data set 20. For example, the illustrated key 16a includes indices to the keys 16b and 16c (e.g., intermediate nodes), and the illustrated keys 16b and 16c include indices to the keys 16d-16i (e.g., leaf nodes). The keys 16d-16i may be considered leaf nodes in that they include values of the data set 20. Thus, storing the set of data in the B plus tree 14 enables the stored data to be linearized and searched rapidly without causing undesirable visual artifacts during display of the data set.

In the illustrated example, the data set is non-uniform. For example, the leaf node associated with the key 16d contains values that constitute a substantially smaller portion of the data set 20 than the values of other leaf nodes such as the leaf node associated with the key 16e. Of particular note is that the illustrated B plus tree 14 provides an efficient solution to storing and searching large amounts of data, particularly when the data is being used in rendering applications that might include pan and/or zoom operations.

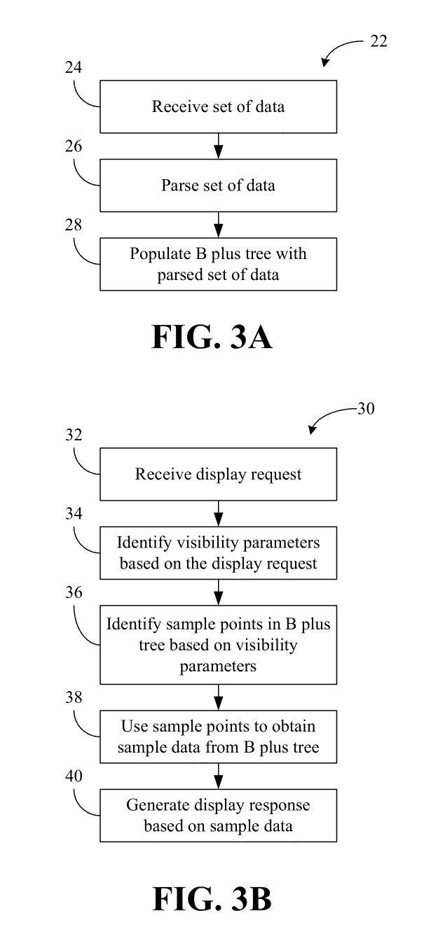

Turning now to FIG. 3A, a method 22 of creating a B plus tree is shown. The method 22 may be implemented as a set of logic instructions stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 22 may be written in any combination of one or more programming languages, including an object oriented programming language such as C++ or the like and conventional procedural programming languages, such as the “C” programming language or similar programming languages. Moreover, the method 22 could be implemented using any of the aforementioned circuit technologies. Illustrated processing block 24 receives a set of data, wherein the set of data may be parsed at block 26. Block 28 may populate a B plus tree such as the B plus tree 14 (FIG. 2), already discussed.

FIG. 3B shows a method 30 of processing display requests. The method 30 may be implemented as a set of logic instructions stored in a machine- or computer-readable storage medium such as RAM, ROM, PROM, flash memory, etc., in configurable logic such as, for example, PLAs, FPGAs, CPLDs, in fixed-functionality logic hardware using circuit technology such as, for example, ASIC, CMOS or TTL technology, or any combination thereof. Illustrate block 32 provides for receiving a display request associated with a set of data. The display request may correspond to, for example, a zoom operation, a pan operation, and so forth. Thus, the display request might be received via a user interface (UI) device such as a mouse, touch pad, touch screen, etc.

One or more visibility parameters may be identified at block 34 based on the display request. The visibility parameters can include, for example, a visibility region, the number of visible pixels in the requested visibility region, and so forth. Block 36 may use a hierarchical sampling scheme to identify one or more sample points in the B plus tree based on the visibility parameters, wherein the sample points can be used to obtain sample data from the B plus tree at block 38. Illustrated block 40 generates a display response based on the sample data.

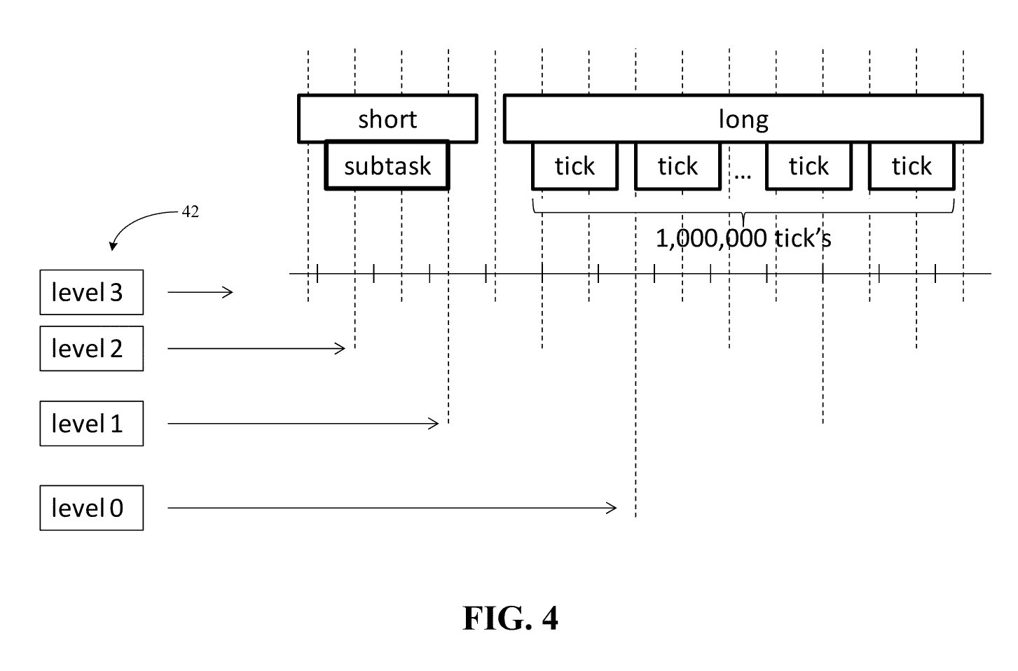

FIG. 4 demonstrates one approach to using a hierarchical sampling scheme to identify sampling points in a B plus tree in greater detail. In particular, the hierarchical sampling scheme may include a plurality of levels 42, wherein given the start and end of the render range (e.g., visibility region) and the number of pixels (e.g., p horizontal pixels) to represent the render range, the level n can be determined such that level(n) contains at least p samples, but less than 2 p. Iterating over the subset of S sample points, wherein S is bounded by the expression p≦S>2 p and subtask states are maintained, may therefore provide sample data from the B plus tree.

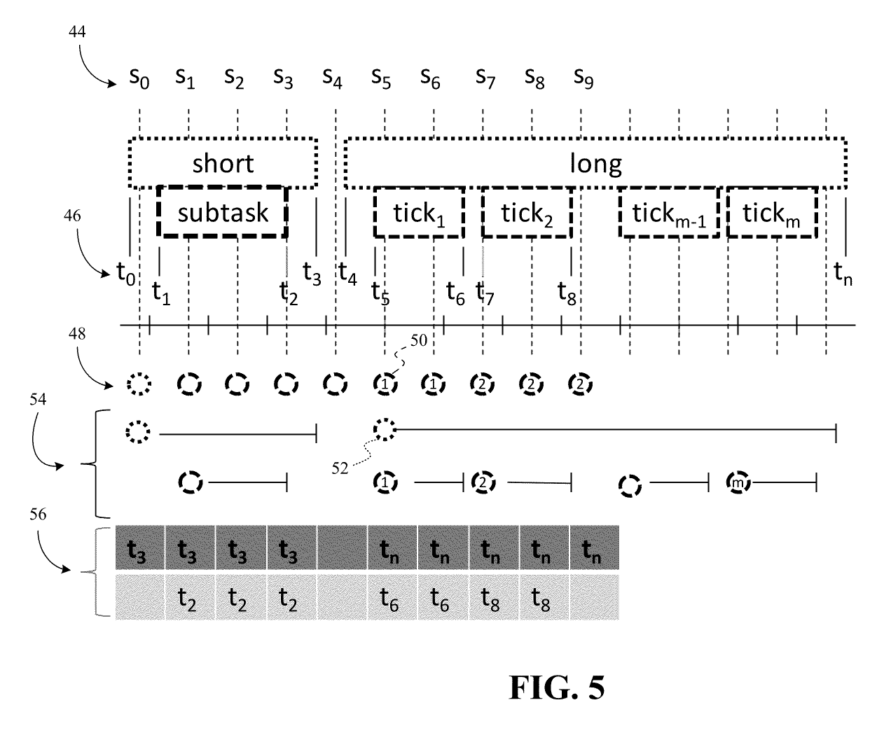

FIG. 5 shows an example application of a hierarchical sampling scheme to a non-uniform set of data stored in a B plus tree. In the illustrated example, the sample indices 44 (e.g., S₀-S₉) are distributed across the short( ) function and the long( ) function. Illustrated task start and end times 46 (e.g., t₀-tₙ) demonstrate that the short( ) function starts at time t₀ and ends at time t₃, which represents a relatively short amount of time. The long( ) function, on the other hand, starts at time t₄ and ends at time tₙ, which represents a relatively long amount of time (i.e., due to the tick( ) function called by the long( ) function).

In general, a task hit at sample move representation 48 demonstrates that moving forward at each sample point allows advancing sample indices 44 to skip redundant samples (e.g., S₂, S₃, S₄, S₆, . . . ). Moreover, the task hit 50 may be at depth two (e.g., in the tick( ) function), which is deeper than long( ) function that calls it. Therefore, a stack counter may be maintained (e.g., indicating depth zero) so that a backwards iteration can be conducted until a depth one task hit 52 occurs, which can be used to fill the gap in the pixel output. Thus, a return representation 54 shows the samples at which tasks are returned and a state representation 56 shows the end time state states at each sample point.

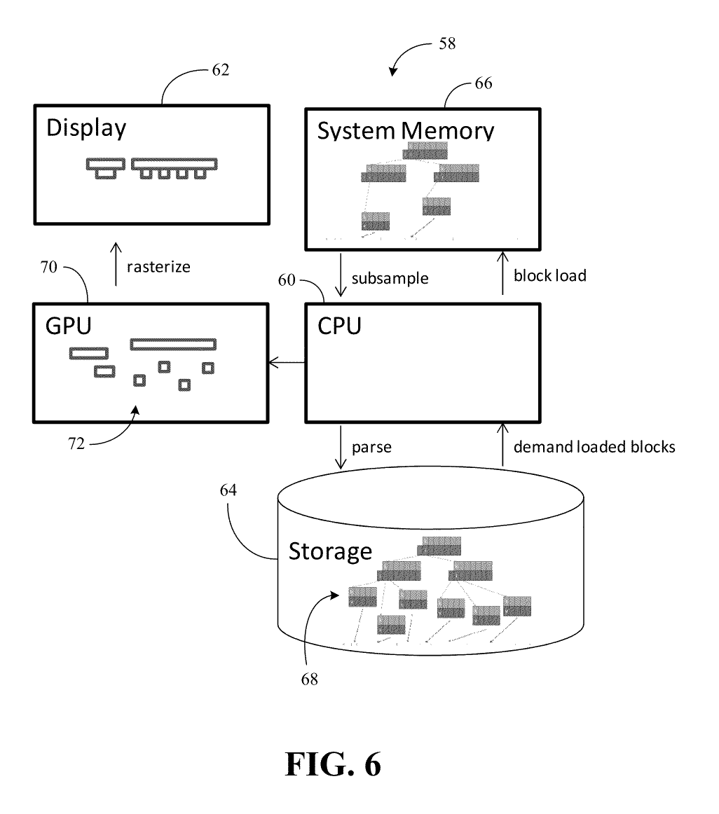

Turning now to FIG. 6, a video-enabled computing system 58 is shown in which a B plus tree is used to render sample data from large data sets. The computing system 58 may be part of a mobile platform such as a laptop, personal digital assistant (PDA), wireless smart phone, media player, imaging device, mobile Internet device (MID), any smart device such as a smart phone, smart tablet and so forth, or any combination thereof. The computing system 58 may also be part of a fixed platform such as a personal computer (PC), smart TV, server, workstation, etc. The illustrated computing system 58 includes one or more CPUs (central processing units) 60, a display device 62, storage (e.g., hard disk drive) 64, one or more GPUs (graphics processing units) 70 and system memory 66, which could include, for example, double data rate (DDR) synchronous dynamic random access memory (SDRAM, e.g., DDR3 SDRAM JEDEC Standard JESD79-3C, April 2008) modules. The modules of the system memory 66 may be incorporated into a single inline memory module (SIMM), dual inline memory module (DIMM), small outline DIMM (SODIMM), and so forth.

In one example, the CPU 60 manages the majority of the B plus tree functionality—loading blocks of a B plus tree 68 from storage 64 to system memory 66 as needed (e.g., on demand per rendering parameters), and then searching through the trees to obtain elements of sampled data. After the elements of data are obtained by the CPU 60, rectangles 72 of data can be send to the GPU 70 display for rendering on the display 62.

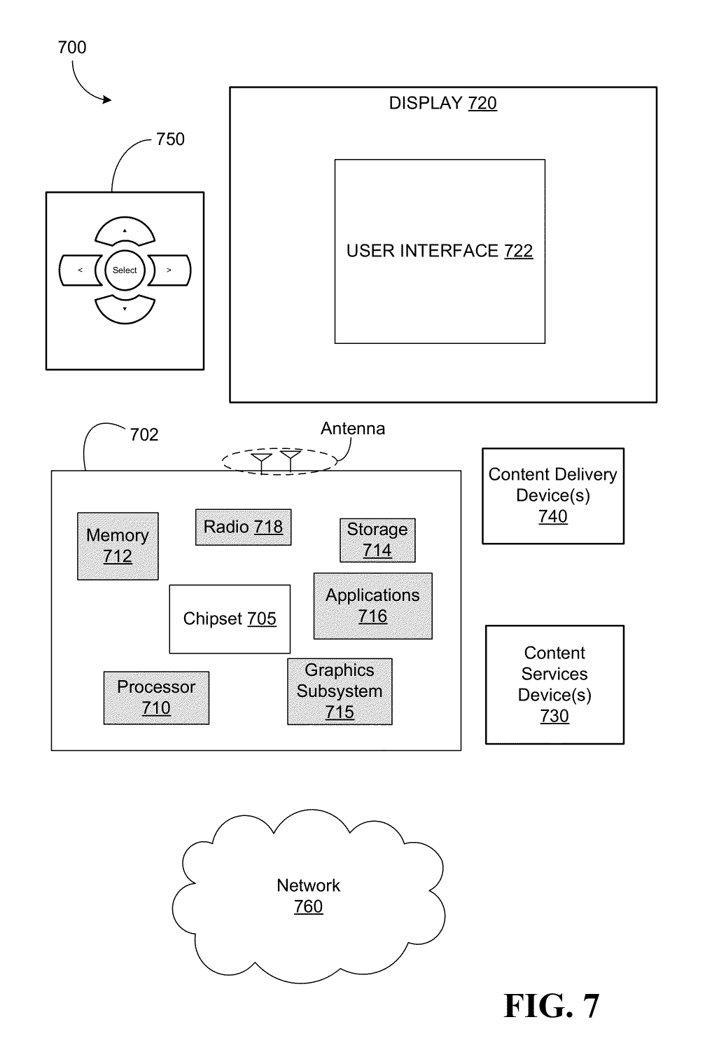

FIG. 7 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

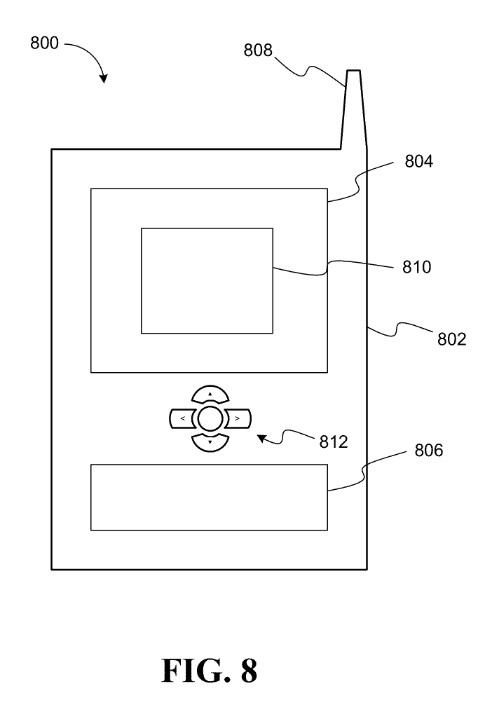

As described above, system 700 may be embodied in varying physical styles or form factors. FIG. 8 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Techniques described herein may therefore provide a feed-forward system that ensures both real-time operation of the consumer video pipeline and dynamic updating of the operating pipeline to deliver optimal visual perceptual quality and viewing experience. In particular, a discrete control system for the video pipeline can dynamically adapt operating points in order to optimize a global configuration of interactive component modules that are related to video perceptual quality. In a series configuration, the perceptual quality analysis module may be placed before the video processing pipeline and parameters determined for the post-processing pipeline may be used for the same frame. In the case of distributed computation of the quality analysis block or when perceptual quality analysis needs to be performed at intermediate points in the pipeline, the parameters determined using a given frame may be applied on the next frame to ensure real-time operation. Distributed computation is sometimes beneficial in reducing complexity as certain elements for perceptual quality computation may already be computed in the post-processing pipeline and can be re-used. Illustrated approaches may also be compatible with closed-loop control where the perceptual quality analysis is re-used at the output of the video processing pipeline to estimate output quality, which is also used by the control mechanism.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
receiving a set of data;
parsing the set of data;
populating a B plus tree with the parsed set of data;
receiving a display request associated with the set of data;
identifying one or more visibility parameters based on the display request, wherein the one or more visibility parameters include one or more of a visibility region and a number of visible pixels;
using a hierarchical sampling scheme to identify one or more sample points in the B plus tree based on the one or more visibility parameters;
using the one or more sample points to obtain sample data from the B plus tree; and
generating a display response based on the sample data.

2. The method of claim 1, wherein the display request corresponds to one or more of a zoom operation and a pan operation.

3. The method of claim 1, wherein the set of data includes a non-uniform set of data.

4. The method of claim 3, wherein the non-uniform set of data includes task data.

5. A computer readable storage medium comprising a set of instructions which, if executed by a processor, cause a computer to:
receive a display request associated with a set of data;
use the display request to obtain sample data from a B plus tree populated with the set of data; and
generate a display response based on the sample data.

6. The medium of claim 5, wherein the instructions, if executed, cause a computer to:
identify one or more visibility parameters based on the display request; and
identify one or more sample points in the B plus tree based on the one or more visibility parameters, wherein the one or more sample points are used to obtain the sample data from the B plus tree.

7. The medium of claim 6, wherein the one or more visibility parameters are to include one or more of a visibility region and a number of visible pixels.

8. The medium of claim 6, wherein a hierarchical sampling scheme is to be used to identify the one or more sample points.

9. The medium of claim 5, wherein the display request is to correspond to one or more of a zoom operation and a pan operation.

10. The medium of claim 5, wherein the instructions, if executed, cause a computer to:
receive the set of data;
parse the set of data; and
populate the B plus tree with the parsed set of data.

11. The medium of claim 5, wherein the set of data is to include a non-uniform set of data.

12. The medium of claim 11, wherein the non-uniform set of data is to include task data.

13. A system comprising:
a memory device to store a set of data in a B plus tree;
logic to,
receive a display request associated with the set of data,
use the display request to obtain sample data from the B plus tree, and
generate a display response based on the sample data; and
a display device to output the display response.

14. The system of claim 13, wherein the logic is to,
identify one or more visibility parameters based on the display request,
identify one or more sample points in the B plus tree based on the one or more visibility parameters, wherein the one or more sample points are used to obtain the sample data from the B plus tree.

15. The system of claim 14, wherein the one or more visibility parameters are to include one or more of a visibility region and a number of visible pixels.

16. The system of claim 14, wherein a hierarchical sampling scheme is to be used to identify the one or more sample points.

17. The system of claim 13, wherein the display request is to correspond to one or more of a zoom operation and a pan operation.

18. The system of claim 13, wherein the logic is to,
receive the set of data,
parse the set of data, and
populate the B plus tree with the parsed set of data.

19. The system of claim 13, wherein the set of data is to include a non-uniform set of data.

20. The system of claim 19, wherein the non-uniform set of data is to include task data.

21. A computer implemented method comprising:
receiving a display request associated with a set of data;
using the display request to obtain sample data from a B plus tree populated with the set of data; and
generating a display response based on the sample data.

22. The method of claim 21, further including:
identifying one or more visibility parameters based on the display request; and
identifying one or more sample points in the B plus tree based on the one or more visibility parameters, wherein the one or more sample points are used to obtain the sample data from the B plus tree.

23. The method of claim 22, wherein the one or more visibility parameters include one or more of a visibility region and a number of visible pixels.

24. The method of claim 22, wherein a hierarchical sampling scheme is used to identify the one or more sample points.

25. The method of claim 21, wherein the display request corresponds to one or more of a zoom operation and a pan operation.

26. The method of claim 21, further including:
receiving the set of data;
parsing the set of data; and
populating the B plus tree with the parsed set of data.

27. The method of claim 21, wherein the set of data includes a non-uniform set of data.

28. The method of claim 27, wherein the non-uniform set of data includes task data.
